(19) United States
(12) Patent Application Publication
(10) Pub. No.: US 2013/0154281 A1
(43) Pub. Date: Jun. 20, 2013

(54) BATTERY SAVING IDLE BUMP WORK MODE

(71) Applicant: Thomas M. Sullivan, Highland, MI (US)

(72) Inventor: Thomas M. Sullivan, Highland, MI (US)

(73) Assignee: CHRYSLER GROUP LLC, Auburn Hills, MI (US)

(21) Appl. No.: 13/326,988

(22) Filed: Dec. 15, 2011

(51) Int. Cl. H02P 9/04

(52) U.S. Cl. 290/40 B

(57) ABSTRACT

An electronic control unit for increasing electrical output from an alternator connected to a variable displacement engine having a plurality of selectively controllable cylinders, the electronic control unit is adapted to determine whether the variable displacement engine is idling, evaluate a present electrical system load; and when the present electrical system load exceeds a present electrical output from the alternator, deactivate at least one of the plurality of cylinders and increase an idle speed of the variable displacement engine. A corresponding method is also disclosed.

### FIELD

The present disclosure relates to maintaining the state of charge in a vehicle energy storage unit, specifically, an automotive battery.

### BACKGROUND

Modern vehicles have numerous electrical and electronic systems that consume significant electrical power, such as high-fidelity sound systems, navigation systems, entertainment systems, and the like. As vehicle technology has advanced, so has the demand on vehicle alternators to provide more electrical current and at higher levels of efficiency. This problem is even greater in public service vehicles, e.g., police cars, which have numerous specialized electrical and electronic systems that can place a heavy energy demand upon the vehicle alternator while the vehicle is parked. Remote start systems also present increased electrical demand as the vehicle idles while running significant current loads.

When a vehicle is parked and idling, the alternator turns relatively slowly, and the resulting electrical current output can be too low to sufficiently power all active electrical and electronic systems. Consequently, the vehicle battery has to make up the difference. A problem often arises when the state of charge of the battery is insufficiently high and electrical system power is too low to meet the demands of the vehicle. This can leave a vehicle unable to restart, or cause inconsistent behavior among the electrical and electronic systems. Chronic undercharging can also shorten battery life by allowing the battery plates to become sulfated. Alternatively, active electrical and electronic systems are turned off to shed the electrical load and minimize battery drain, which inconveniences the driver.

Electronic control devices are available which can automatically increase the idle RPM level of the engine above a normal idle RPM level when needed to increase electrical current output of a connected alternator to prevent or at least limit the rate of discharge of the battery. As can be seen in FIG. 1, the electric current output curve of a vehicle alternator is relatively linear in the general range in which an engine idles. For example, a doubling in idle speed from, e.g., 800 RPM to 1600 RPM will generally result in a doubling of electric current output. Such devices are capable of keeping engine RPMs sufficiently high regardless of variations in engine loading. Such electronic control devices have drawbacks, however, as this increase in idle speed comes with a concomitant increase in fuel consumption and emissions. The electronic control devices also fail to take advantage of specialized engine technology, such as variable displacement.

### SUMMARY

In various example embodiments, the present disclosure provides an electronic control unit for increasing electrical output from an alternator connected to a variable displacement engine having a plurality of selectively controllable cylinders (e.g., eight cylinders). The electronic control unit is adapted to determine whether the variable displacement engine is idling and evaluate a present electrical system load. When the present electrical system load exceeds a present electrical output from the alternator, the electronic control unit deactivates at least one of the plurality of cylinders (e.g., four) and increases (e.g., doubles) an idle speed of the variable displacement engine. The increase in idle speed and decrease in active cylinders results in an increase in output without a concomitant increase in emissions.

Optionally, the idle speed is increased until the electrical output from the alternator exceeds the present electrical system load. The electronic control unit can also be further configured to periodically reevaluate the present electrical system load to determine if a further increase in idle speed is needed. The electronic control unit can be further adapted to evaluate a state of charge of the battery and both deactivate at least one of the plurality of cylinders and increase the idle speed of the variable displacement engine only if the state of charge of the battery is below a threshold level.

The variable displacement engine can have at least two banks of cylinders, and the at least one of the plurality of cylinders deactivated by the electronic control unit (while increasing the idle speed of the variable displacement engine) can comprise the cylinders in at least one of the banks of cylinders. The cylinders in the at least one of the banks of cylinders can have a greater displacement than the cylinders in at least one of the other banks of cylinders, and these larger displacement cylinders can be presumptively selected for deactivation.

The present disclosure also provides a corresponding method for increasing electrical output from an alternator connected to a variable displacement engine having a plurality of selectively controllable cylinders. The method comprises deactivating at least one of the plurality of cylinders and increasing an idle speed of the variable displacement engine. In the disclosed method, the deactivating and increasing steps can be performed in response to receipt of an idle bump mode activation signal.

Further areas of applicability of the present disclosure will become apparent from the detailed description and claims provided hereinafter. It should be understood that the detailed description, including disclosed embodiments and drawings, are merely exemplary in nature intended for purposes of illustration only and are not intended to limit the scope of the invention, its application or use. Thus, variations that do not depart from the gist of the invention are intended to be within the scope of the invention.

### BRIEF DESCRIPTION OF THE DRAWINGS

FIG. 1 is a graph showing an exemplary alternator electrical output curve;

FIG. 2 is a schematic showing an exemplary electronic control unit and connected components in a vehicle powertrain;

FIG. 3 is a flowchart showing one embodiment for increasing electrical output from an alternator connected to a variable displacement engine;

FIG. 4 is a schematic showing an exemplary electronic control unit and connected components in an alternative vehicle powertrain; and

FIG. 5 is a schematic showing an exemplary electronic control unit and connected components in another alternative vehicle powertrain.

### DETAILED DESCRIPTION OF THE FIGURES

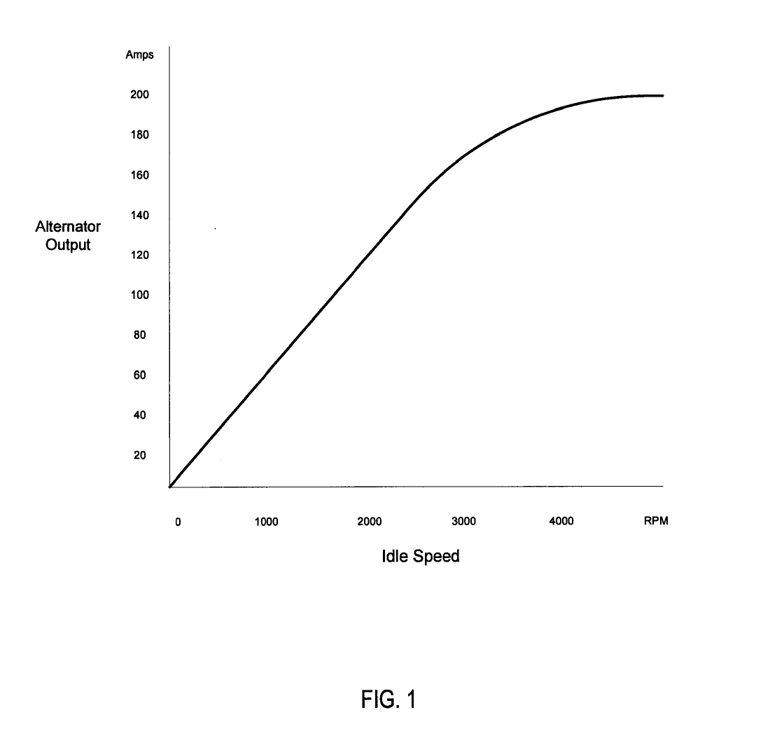

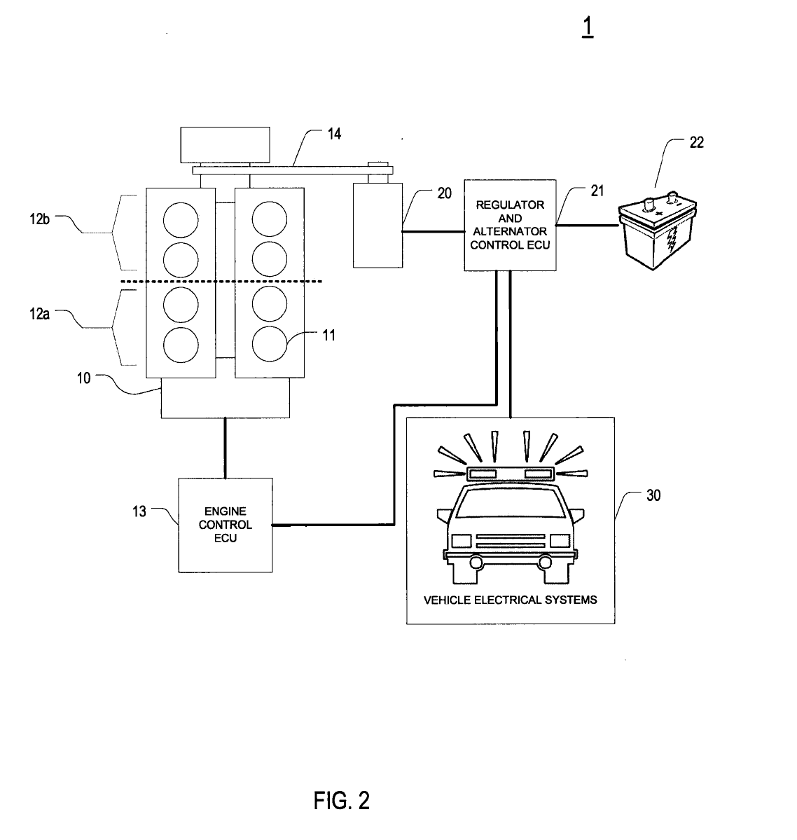

FIG. 2 illustrates an exemplary alternator control electronic control unit (ECU) 21 and connected components in a vehicle powertrain 1. A variable displacement engine 10 is provided having a plurality of cylinders 11. The cylinders can be divided into a plurality of banks 12a, 12b, each comprising at least one cylinder. As can be seen in FIG. 1, the engine 10 comprises eight cylinders 11, bank 12a comprises four cylinders 11 and bank 12b comprises four cylinders 11. An engine control electronic control unit 13 controls operation of the cylinders, including whether one or more cylinders are to be deactivated. A serpentine belt 14 or other connection means connects engine 10 to alternator 20, allowing engine 10 to drive alternator 20. The alternator control electronic control unit 21 can also be a voltage and current regulator to a plurality of connected vehicle electric and electronic systems 30. A battery 22 is also provided to store electrical energy for use when alternator 20 is producing insufficient output. It is of course understood that the functions of the alternator control electronic control unit 21 and engine control electronic control unit 13 can be merged in a single electronic control unit, or shared between several separate electronic control units.

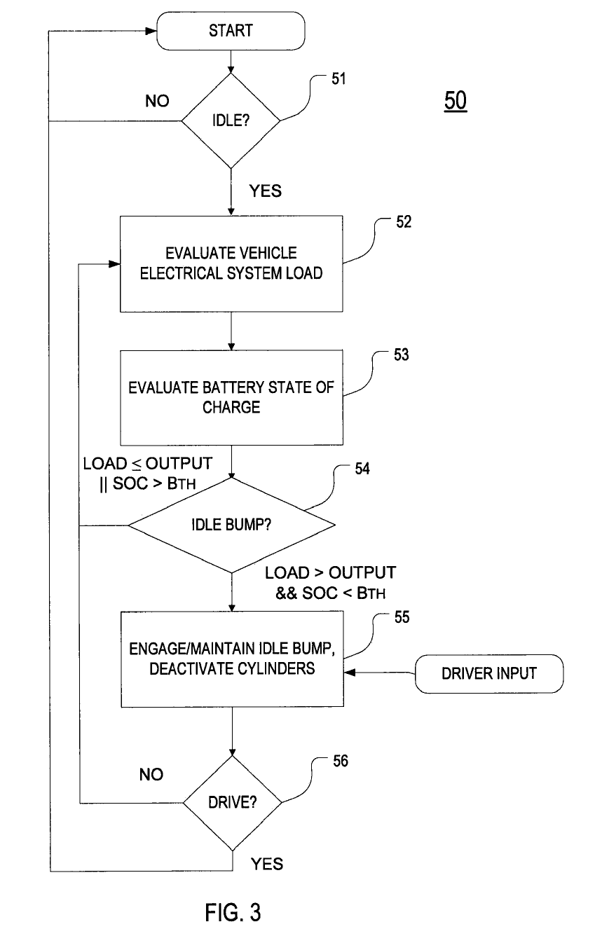

FIG. 3 illustrates an exemplary method 50 that can be performed by the alternator control electronic control unit 21 to increase electrical output from the alternator 20 when the system load from connected vehicle electric and electronic systems 30 is exceeding the present electrical output from the alternator 20. In a first step 51, the alternator control electronic control unit 21 determines if the vehicle is idling. If so, at step 52, the alternator control electronic control unit 21 evaluates the present system load from the connected vehicle electric and electronic systems 30. An optional step 53 has alternator control electronic control unit 21 evaluate the current state of charge of battery 22. At step 54, the alternator control electronic control unit 21 determines whether an idle speed bump should be implemented. In an embodiment where only the present system load is evaluated, an idle speed bump can be implemented any time the system load from the connected vehicle electric and electronic systems 30 is exceeding the present electrical output from the alternator 20. If the current state of the battery 22 is also evaluated at step 53, the step 54 determination whether to implement an idle speed bump can be made to depend on the current state of charge of the battery 22. If the state of charge of the battery 22 is above a threshold level, for instance, eighty percent charged, idle speed bump implementation can be delayed. Alternatively the idle speed bump can be selectively activated by a driver input, e.g., by a switch on the dashboard or selection of an option on an on-board computer, or by the driver remote starting the vehicle.

At step 55 the idle speed bump is implemented by raising the present idle speed of the engine 10 while also deactivating one or more of the cylinders 11. The increase in idle speed and decrease in active cylinders results in an increase in electrical output from alternator 20 without a concomitant increase in emissions. The idle speed bump can be deactivated when the vehicle begins driving (step 56).

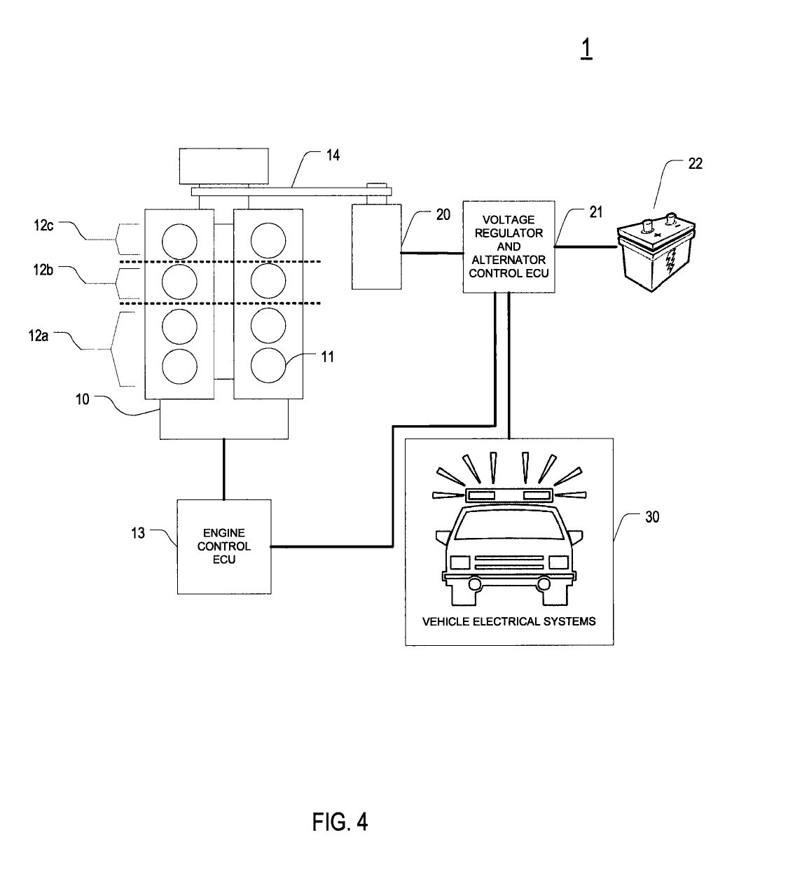

FIG. 4 illustrates an another embodiment of an exemplary alternator control electronic control unit 21 and connected components in a vehicle powertrain 1 in which the cylinders 11 are divided into multiple banks 12a, 12b, and 12c of different sizes. As can be seen in FIG. 4, the engine 10 comprises eight cylinders 11. Bank 12a comprises four cylinders 11 and banks 12b and 12c comprise two cylinders 11 each. In such an embodiment, one or more of the banks can be selectively deactivated in the idle bump mode and the idle speed raised proportionately. For instance, if 6 of 8 cylinders remain operating, idle speed can be raised 33%. Although depicted as such, it should be understood that a bank need not comprise opposing cylinders 11 and can comprise any of the cylinders 11 in the engine 10. For instance, the cylinders 11 in each bank 12a, 12b, and 12c may be determined by cylinder firing order.

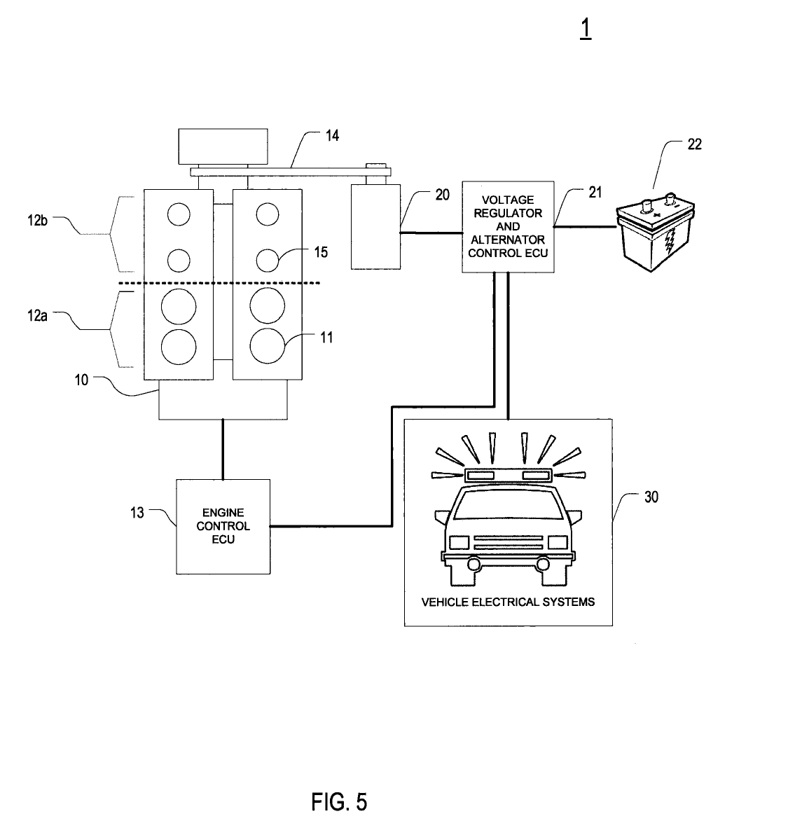

FIG. 5 illustrates yet another embodiment of an exemplary alternator control electronic control unit 21 and connected components in a vehicle powertrain 1 in which cylinders of different sizes are incorporated in engine 10. As can be seen in FIG. 5, engine 10 has two banks 12a and 12b, but the cylinders 11 in bank 12a are larger than the cylinders 15 in bank 12b. In such a configuration, bank 12a, which has the larger cylinders 11, can be deactivated during the idle speed bump so that further efficiencies in fuel consumption and emissions levels can be achieved.

What is claimed is:

1. An electronic control unit for increasing electrical output from an alternator connected to a variable displacement engine having a plurality of selectively controllable cylinders, the electronic control unit adapted to:
determine whether the variable displacement engine is idling;
evaluate a present electrical system load; and
when the present electrical system load exceeds a present electrical output from the alternator:
deactivate at least one of the plurality of cylinders; and
increase an idle speed of the variable displacement engine.

2. The electronic control unit of claim 1, wherein the idle speed is increased until the electrical output from the alternator exceeds the present electrical system load.

3. The electronic control unit of claim 1, wherein the electronic control unit is further configured to periodically reevaluate the present electrical system load to determine if a further increase in idle speed is needed.

4. The electronic control unit of claim 1, wherein the electronic control unit is additionally connected to a battery and further adapted to evaluate a state of charge of the battery.

5. The electronic control unit of claim 4, wherein the electronic control unit is further adapted to deactivate at least one of the plurality of cylinders and increase the idle speed of the variable displacement engine only if the state of charge of the battery is below a threshold level.

6. The electronic control unit of claim 1, wherein the variable displacement engine has at least two banks of cylinders, and the at least one of the plurality of cylinders deactivated by the electronic control unit while increasing the idle speed of the variable displacement engine comprises the cylinders in at least one of the banks of cylinders.

7. The electronic control unit of claim 6, wherein the variable displacement engine has at least three banks of cylinders.

8. The electronic control unit of claim 6, wherein the cylinders in at least one of the banks of cylinders have a greater displacement than the cylinders in at least one of the other banks of cylinders.

9. The electronic control unit of claim 8, wherein the at least one bank of cylinders with larger displacement cylinders are deactivated by the electronic control unit while increasing the idle speed of the variable displacement engine.

10. The electronic control unit of claim 1, wherein the variable displacement engine has eight cylinders, and the electronic control unit deactivates four of the eight cylinders when increasing the idle speed of the variable displacement engine and the increase in idle speed comprises doubling the idle speed.

11. The electronic control unit of claim 1 further comprising an input to receive an idle bump activation signal, the electronic control unit being configured to deactivate at least one of the plurality of cylinders and increase the idle speed of the variable displacement engine in response to receipt of the idle bump activation signal.

12. A method for increasing electrical output from an alternator connected to a variable displacement engine having a plurality of selectively controllable cylinders, the method comprising:
deactivating at least one of the plurality of cylinders; and
increasing an idle speed of the variable displacement engine.

13. The method of claim 12, further comprising:
determining whether the variable displacement engine is idling; and
evaluating a present electrical system load.

14. The method of claim 13, wherein the deactivating and increasing steps are performed only if the present electrical system load exceeds a present electrical output from the alternator.

15. The method of claim 13, further comprising:
evaluating a state of charge of a connected battery.

16. The method of claim 15, wherein the deactivating and increasing steps are performed only if the present electrical system load exceeds a present electrical output from the alternator and the state of charge of the connected battery is below a threshold level.

17. The method of claim 12, wherein the deactivating and increasing steps are performed in response to receipt of an idle bump activation signal.

18. The method of claim 12, wherein increasing the idle speed comprises doubling the idle speed.

19. The method of claim 12, wherein the variable displacement engine has eight cylinders, and the electronic control unit deactivates four of the eight cylinders when increasing the idle speed of the variable displacement engine.

20. The method of claim 12, wherein the variable displacement engine has at least two banks of cylinders, and the deactivating comprises deactivating at least one of the banks of cylinders.
